(19) United States
(12) Patent Application Publication
(10) Pub. No.: US 2012/0143986 A1
(43) Pub. Date: Jun. 7, 2012

(54) SYSTEMS AND METHODS FOR DOWNLOADING BY DIFFERENT PROCESSES

(75) Inventors: Aaron C. Robinson, San Diego, CA (US); Jim Hedley Reesman, San Diego, CA (US)

(73) Assignee: Rovi Technologies Corporation, Santa Clara, CA (US)

(21) Appl. No.: 13/308,322

(22) Filed: Nov. 30, 2011

Related U.S. Application Data
(60) Provisional application No. 61/418,376, filed on Nov. 30, 2010.

(51) Int. Cl. G06F 15/16

(52) U.S. Cl. 709/217

(57) ABSTRACT

Systems and methods in accordance with embodiments of the invention are disclosed that use network connected devices that simultaneously use multiple different download processes to download different portions of a file. One embodiment of the invention includes a network connected device, including: a processor; memory containing a download manager application; where the download manager application configures the processor to utilize a plurality of different download processes to download portions of the same piece of content from at least one download source.

### CROSS-REFERENCE TO RELATED APPLICATIONS

The current application claims priority to U.S. Provisional Patent Application No. 61/418,376, filed Nov. 30, 2010, the disclosure of which is incorporated herein by reference.

### FIELD OF THE INVENTION

The present invention generally relates to network connected devices and more specifically to network connected devices incorporating a download management system.

### BACKGROUND

The prevalence of digital content has increased with advances in communications. Practically immediate access to large data sets over a network, such as the Internet, is now commonplace. This has likewise fueled a need for fast, efficient and effective download and playback techniques that are able to meet the demand for immediately available digital content. The term “download” is generally used to indicate a process of receiving content from a remote server over a network to be utilized locally on a network connected device, such as for content playback.

Current content distribution solutions entail storing content so that it is accessible via the Internet. There are many processes by which data may be downloaded via the Internet. Client/server and peer-to-peer (P2P) network architectures are two major forms of networking architectures for downloading data via the Internet. Content can be encoded to reduce file size and lower download time. Encoded content can be decoded by playback devices and played back.

Client/server is a term typically used to describe applications that divide processing among two or more processes. In this architecture, tasks are partitioned between the providers of a resource, called servers, and service requesters, called clients. For example, a server is a process that stores data and the client is a process that retrieves stored data or creates data. In another example, a user may open a web page and click on a link to download a file to the user's computer. The Web browser software on the user's computer (i.e. the client) tells the server, a central computer that holds the Web page and possibly the file to be downloaded, to transfer a copy of the file to the computer. Typically, the transfer is handled by a protocol, which is a set of rules, such as Hypertext Transfer Protocol (HTTP) or Hypertext Transfer Protocol Secure (HTTPS). The idea behind the client/server architecture is to provide multiple users with access to the same data. There are typically separate dedicated servers and clients in a client/server network. Advantages of client/server architectures include ease of maintenance, uniformity of data and security. However, the transfer speed in the client/server model is affected by a number of variables, including the type of protocol, the amount of traffic on the server, and the number of other clients that are downloading a file. If the file is both large and popular, the demands on the server are great and a slow download can result.

Hypertext Transfer Protocol, or HTTP, is a request-response protocol in the client/server computing model. In HTTP, a web browser may act as a client while applications running on a computer hosting a web site functions as a server. The client submits an HTTP request message to the server. The server then can perform the requested functions for the client and may respond to the client with the requested data. In HTTP downloading, the client seeks out a particular server or group of servers using an identifier such as a Universal Resource Locator (URL).

Hypertext Transfer Protocol Secure, or HTTPS, is a combination of HTTP with the Transport Layer Security (TLS)/Secure Sockets Layer (SSL) protocol to provide encrypted communication.

File Transfer Protocol (FTP) is another network protocol in the client/server computing model typically utilized to transfer files from one host to another with separate control and data connections between a client and server.

Peer-to-peer (P2P) networking is a distributed application architecture that partitions tasks between peers. A peer may be a computer, utilized by a user, on a network. Each peer is equally privileged relative to other peers. Peers make a portion of their resources, such as processing power, disk storage or network bandwidth, directly available to other network participants, without the need for central coordination by servers or stable hosts. In P2P, communications according to the P2P protocol are used to locate devices that can provide access to a desired file as opposed to a predetermined URL. Stated another way, in P2P the location of a file is typically determined as part of the downloading of the file. By contrast, most client/server models rely upon the location of the file being known prior to the client attempting to download the file from the specified server. There are many forms of P2P software such as Gnutella and BitTorrent. Advantages of a P2P network include robustness as there is no need to rely on a centralized server and adaptability as system capacity increases with an increase in peers.

In P2P software such as Gnutella, an open source protocol used by various clients, a first peer may run a P2P application and send out a request for a desired file. The software queries other computers, or peers, that are connected to the Internet and running the P2P application. When the P2P application finds a peer that has access to the desired file, the download begins. Other peers can also obtain their desired files from the first peer. The data sent and received during the download and search process from the first peer and other peers may cause bottlenecks and cause slow downloads. Also, some peers may download files and immediately disconnect without allowing other peers to download the file from their system. This limits the number of peers from which the software can search for the requested file.

In a P2P application such as BitTorrent maintained by BitTorrent, Inc. of San Francisco, Calif., a peer with an active BitTorrent application opens a Web page and clicks on a desired file. The BitTorrent application communicates with a tracker, which is a central server that takes some of the file tracking work away from the peer that is using the P2P software. The desired file is not downloaded from the server, in contrast to a client/server model. The tracker helps the peer find other peers running the BitTorrent application that have the complete file, which are known as seeds, as well as peers with a portion of the file, usually due to the fact that they are in the process of downloading the file. The tracker identifies the swarm, which are connected peers that have all or a portion of the file and are in the process of sending or receiving the desired file. The tracker helps a peer to trade pieces of the desired file with other peers in the swarm. If the BitTorrent application is still running after the download is completed, other peers can receive torrent files from the peer's computer which raises the peer's ranking under the tit-for-tat system. Future download rates improve with a higher ranking in the tit-for-tat system. By downloading multiple parts of a file from different sources at the same time, the overall speed is greatly improved. The more peers involved in the swarm, the faster the file transfer occurs as there are more sources for each piece of the file. BitTorrent is particularly useful for large, popular files.

A difference between client/server and P2P is that a peer can download from any other peer that has the desired file in the P2P model but a server typically does not download a file from a client in the client/server model. In P2P, peers are both suppliers and consumers of resources. However, in the client/server model only servers supply, and clients consume. Another difference between a P2P process and a client/server process is that simultaneous upload and download can occur within a P2P process. In an example where a first peer is downloading portions of a file from a second peer, a third peer may also download portions of the incomplete file on the first peer while the first peer is downloading other portions of the incomplete file from the third peer. In a client/server model, a server typically provides a complete file for download to a client.

The playback of content downloaded on the Internet has traditionally been download-and-play technology. With early playback technologies, the entire content file was downloaded prior to playback. However, recent developments in progressive downloads and streaming downloads have allowed users to play back content while the content is being downloaded. An advantage of this type of download is in providing the user with nearly instantaneous enjoyment of the content following download initiation.

In progressive downloads, the user may begin content playback from start to finish while the content is downloading. The playback is almost instantaneous and occurs only after a short wait for buffering (i.e. the process of collecting the first part of a content file before playing). The buffer can enable the content playback to continue uninterrupted even during periods of high network congestion. Progressive downloads typically rely on the metadata of the required information to begin playback as the file is being downloaded, located in the header of the file, to be intact and on the local buffer to play. The downloaded file then is stored in local storage on the user's computer.

In streaming downloads, the user may also play content while the content is downloading but typically utilizes additional software on the user's computer as well as an additional streaming server to service the streaming process. For example, a user may use a web browser to find a Web page that features streaming content. Upon selecting to view the streaming content, the Web server hosting the Web page requests the file from the streaming server. The streaming server sends pieces of the file to the user's computer. Many streaming systems can dynamically respond to changes in the streaming conditions (e.g. network performance or video decoder performance) in order to provide uninterrupted content playback. Such systems are typically referred to as adaptive bitrate streaming systems.

### SUMMARY OF THE INVENTION

Network connected devices in accordance with embodiments of the invention include a download manager configured to download content using a plurality of different download processes to obtain different portions of the content. In many embodiments, the different download processes include a first client/server download process and a second peer-to-peer download process. In a number of embodiments, a first download process involves requesting the download of a file using an identifier indicative of a location of a file on a server and the second download process involves identifying at least one peer device that has access to a copy of the file that is on the server. One embodiment of the invention includes a network connected device, including: a processor; memory containing a download manager application; where the download manager application configures the processor to utilize a plurality of different download processes to download portions of the same piece of content from at least one download source.

In a further embodiment, the plurality of different download processes are plug-ins to the download manager application.

In another embodiment, the plurality of different download processes include a HTTP download process and a P2P download process.

In a still further embodiment, at least one of the plurality of different download processes are selected from a group consisting of HTTP, HTTPS, FTP and P2P download processes.

In a still another embodiment, the download manager application includes a player configured to playback partially downloaded content.

In a yet further embodiment, the download manager application is configured to download content from a single download source.

In yet another embodiment, the download manager application is configured to download content from a plurality of download sources.

In a further embodiment again, the download manager application is configured to operate as a background process.

Another embodiment again includes a method of downloading a piece of content using a network connected device, the method including: downloading portions of a piece of content from at least one download source utilizing a plurality of different download processes using a network connected device; and storing the portions of downloaded content on the network connected device.

In another additional embodiment, the downloading portions of a piece of content from at least one download source utilizing a plurality of different download processes includes: determining a portion of content to be downloaded; allocating the portion of content to one of the plurality of download process; and downloading the portion of content according to the download process.

In a still yet further embodiment, the plurality of different download processes are plug-ins to a download manager application that configures the network connected device to download portions of a piece of content from at least one download source using the plurality of different download processes.

In a still yet further embodiment, the plurality of different download processes include a HTTP download process and a P2P download process.

In a still yet another embodiment, at least one of the plurality of different download processes is selected from a group consisting of HTTP, HTTPS, FTP and P2P download processes.

In a still further embodiment again, the method includes playing back the partially downloaded piece of content during the downloading of the piece of content using the network connected device.

In still another embodiment again, the portions of the piece of content are downloaded from a single download source.

In still further additional embodiment, the portions of the piece of content are downloaded from a plurality of download sources.

A still another additional embodiment includes a machine readable medium containing processor instructions, where execution of the instructions by a processor causes the processor to perform a process including: downloading portions of a piece of content from at least one download source utilizing a plurality of different download processes using a network connected device; and storing the portions of downloaded content on the network connected device.

In another further additional embodiment, the process of downloading portions of a piece of content from at least one download source utilizing a plurality of different download processes further includes: determining a portion of content to be downloaded; allocating the portion of content to one of the plurality of download process; and downloading the portion of content according to the download process.

In another further additional embodiment, the machine readable medium is non-volatile memory.

### BRIEF DESCRIPTION OF THE DRAWINGS

FIG. 1 illustrates a network diagram of a file transfer system in accordance with an embodiment of the invention.

FIG. 2 illustrates a download manager configured to download content utilizing different plug-in download processes in accordance with an embodiment of the invention.

FIG. 3 is a flow chart illustrating a process for downloading content using different download processes in accordance with an embodiment of the invention.

FIG. 4 illustrates a number of plug-in download processes that can be utilized by a download manager in accordance with an embodiment of the invention, namely an HTTP download process, HTTPS download process, FTP download process and P2P download process.

FIG. 5 is a flow chart illustrating a process for downloading content using a plurality of different download processes in accordance with an embodiment of the invention.

### DETAILED DESCRIPTION

Turning now to the drawings, network connected devices that simultaneously use multiple different download processes to download different portions of a file in accordance with embodiments of the invention are illustrated. In many embodiments, a network connected device can download content utilizing different processes for downloading content, or pulling content from a remote content server onto a local device. In certain embodiments, these different download processes include both P2P network architecture and client/server network architectures, including but not limited to HTTP, HTTPS and FTP. Utilizing both a client/server download process and a P2P download process can reduce the bandwidth requirement of servers used to distribute content by transferring a portion of the download burden to other users, who may act as peers for certain portions of the file. In many embodiments, only portions of a file are downloaded from a server via HTTP. The remainder of the file can be downloaded using a P2P process utilizing resources from other network connected devices in accordance with embodiments of the invention acting as peers, which can reduce the burden on the server.

In many embodiments, P2P and client/server download processes are used to supplement streaming content and/or progressive downloading. Downloading of portions of a content file using different processes can be coordinated to obtain portions of the content before they are utilized for playback. Thereby, faster download speeds may occur in progressive downloads with the integration of multiple client/server or P2P download processes. Also, streaming may be more efficient with a streaming server overseeing the streaming process but also directing certain download processes from P2P sources. Thereby, network connected devices can support content playback of incomplete files. Progressive playback or streaming can be performed while utilizing multiple download processes to download different portions of a file such that content that is immediately required for playback is streamed while other portions of the content file are downloaded by other processes, such as the client/server download model or the P2P download model. Thereby, users can enjoy nearly immediate gratification of content playback requests while efficiently employing multiple download processes to reduce the burden on content servers as playback progresses. In several embodiments, network connected devices both stream and save downloaded content obtained via multiple download processes. When the download process is complete the network connected device can locally save the content.

Particular embodiments include converting files into other formats, including multiplexing or demultiplexing files. Examples of a number of these embodiments include changing file container formats. Numerous embodiments provide for a web player that may multiplex, or mux, an MP4 container of a Flash video into an MKV file. MP4, or MPEG-4 Part 14 is a multimedia container format specified as part of the MPEG-4 standard commonly used to store digital content. MPEG-4 defines a standard for the compression of audio and visual (AV) digital data agreed upon by the ISO/IEC Moving Picture Experts Group (MPEG) (ISO/IEC JTC1/SC29/WG11) under the formal standard ISO/IEC 14496—Coding of audio-visual objects. MKV, or the Matroska Multimedia Container is an open container format with implementations consisting mostly of open source software, which can hold an unlimited number of video, audio, picture or other content inside a single file. Flash or Adobe Flash, developed by Adobe Systems Incorporated of San Jose, Calif., is a multimedia platform that may be used to add animation or interactivity to Web pages. Flash is capable of playing back Small Web Format (SWF) files, which is a file format specified by Adobe Systems Incorporated for multimedia, vector graphics, and ActionScripts. Certain embodiments provide for downloading a file with a post processing step for remux. Certain embodiments provide for a remux into a new container on downloading.

Many embodiments also provide for synchronization of content libraries via universal plug and play (UPnP). Universal plug and play is a set of networking protocols that can provide for dynamically attaching devices directly to a computer, which may allow for automatically establishing working configurations with other devices. Numerous embodiments provide for applications such as downloading content from a desktop computer, or other device, while simultaneously watching the content on a television, or other device, as the content is downloading or vice versa.

Network connected devices and the downloading of content files for playback using a number of different downloading processes in accordance with embodiments of the invention are discussed further below.

### System Architecture

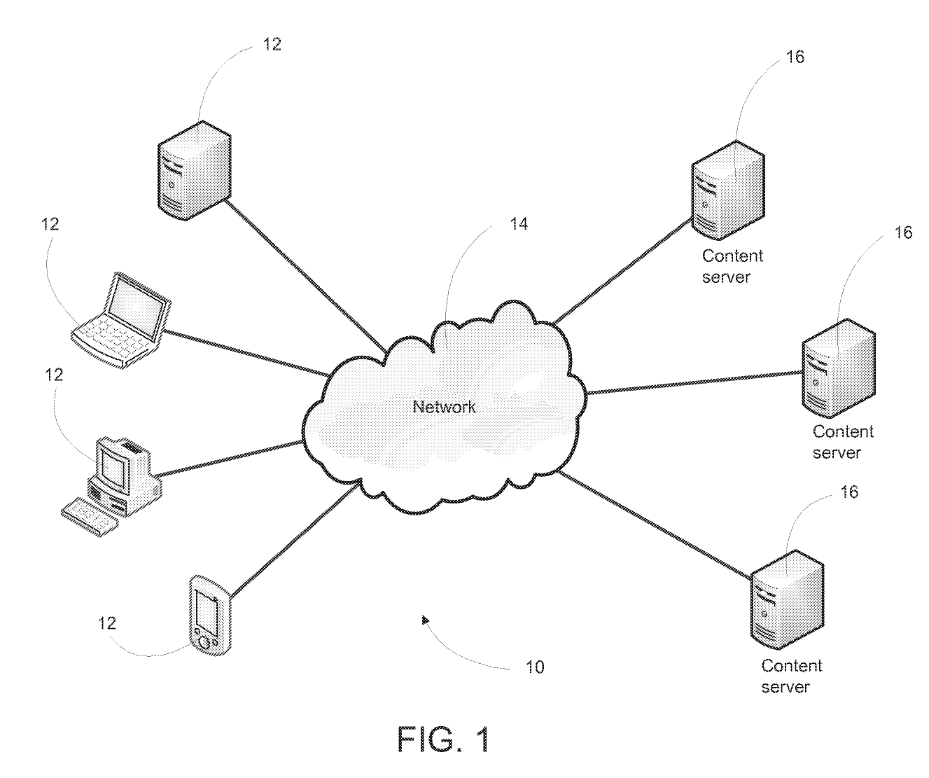

Network connected devices in accordance with embodiments of the invention can download content from a variety of download sources using different download processes over a network, such as the Internet. In many embodiments, network connected devices include downloaded microprocessor instructions that enable playback of downloaded content stored in memory, including non-volatile memory or any other machine readable medium. Downloading different parts of a content file or downloading different content files through different download processes adds more resources for the download of content files, enabling faster and more efficient content downloads by avoiding download bottlenecks at a single download process or from a single download source. A network diagram of a system including various network connected devices downloading content from different download sources using different download processes is illustrated in accordance with an embodiment of the invention in FIG. 1. The system 10 includes various network connected devices 12 connected via a network 14 to a plurality of download sources 16. In the illustrated embodiment, the network connected device 12 may be a personal computer. In many embodiments, the network connected device 12 can be implemented as a mobile phone, a consumer electronics device such as (but not limited to) a gaming console or an Internet connected television and/or any other type of device capable of downloading content via a network such as the Internet. Certain embodiments feature download sources 16 such as, but not limited to, peers or servers. Servers may be, but are not necessarily, dedicated servers. Also, peers may be any electronic device such as other network connected devices or even servers. The network in certain embodiments may be, but is not limited to, the Internet.

In many embodiments, a network connected device may be configured to download files from different sources using two or more different processes. In certain embodiments, the network connected device uses a client/server process and a P2P process. In several embodiments, the network connected device may use one process where a client requests the downloading of a file using an identifier indicative of a location of a file on a server. The network connected device may also use another process that commences after communication with a remote process to identify a seed file and peer devices that have access to portions of the seed file. The network connected device can then request access to at least a portion of the file from one or more of the identified peer devices. Further embodiments include integration of progressive downloading of content for immediate playback and downloading other portions of a content file that are not immediately required for playback. Yet other embodiments also include streaming of content immediately requested for content playback and saving the streamed content locally to be constituted with other parts of the content file downloaded using different processes.

In several embodiments, network connected devices also include players to enable playback of downloaded content. In many embodiment, playback can be performed even while content is being downloaded. Many embodiments include players that are integrated with the download manager to allow for an easier and more intuitive user experience where a user need not wait for an entire content file to be downloaded but can also enjoy playback of partially downloaded content as the content is being downloaded.

Although a specific file transfer system is illustrated above, file transfer systems can be implemented in any of a variety of configurations including by implementing any number of different download processes in addition to P2P and client/server download processes in accordance with embodiments of the invention. Network connected devices and download managers in accordance with embodiments of the invention are discussed further below.

### Network Connected Devices

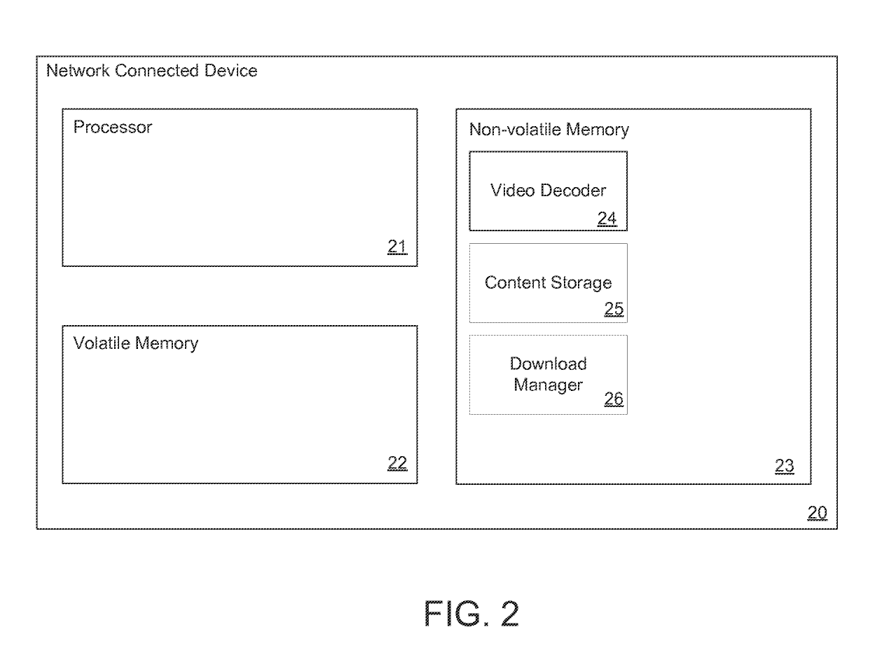

A network connected device including a download manager where content is downloaded and locally stored using plug-in download processes and an integrated player to playback content in accordance with an embodiment of the invention is illustrated in FIG. 2. The network connected device 20 includes a processor 21, volatile memory 22, and non-volatile memory 23. In the illustrated embodiment, the non-volatile memory is a machine readable media that is utilized to store the machine readable instructions that configure the processor. The non-volatile memory 23 contains the instructions (24) utilized to configure the processor to playback downloaded content. The non-volatile memory is also utilized for storage of downloaded content (25) and includes instructions utilized to configure the processor to perform a download manager process (26). In many embodiments of the invention the download manager process (26) includes a plurality of plug-in processes (see discussion below).

In many embodiments, the player and the download manager processes are integrated to enable the download manager process to allocate portions of content to different download processes based upon the needs of the player. In this way, playback can commence prior to the complete downloading of the content. In other embodiments, the player and the download manager are separate and/or located on separate devices.

Although a specific implementation of a network connected playback device is illustrated in FIG. 2, a download manager can be implemented on any of a variety of network connected playback devices including playback devices that utilized disk storage and/or on multiple devices such as the combination of a network connected device and a removable storage device or even devices that synchronize files with the download device. Download managers and the downloading of content using different processes is discussed further below.

### Download Managers

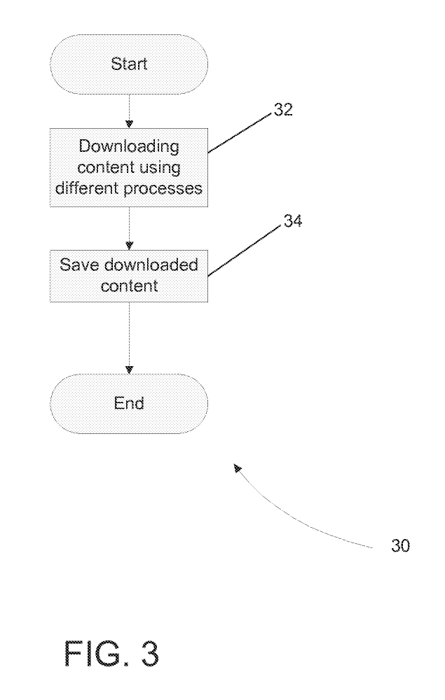

Download managers in accordance with many embodiments of the invention integrate different download processes that enable downloading of content over a network to be saved locally on a network connected device. A download process in accordance with an embodiment of the invention is illustrated in FIG. 3. The download process 30 includes downloading (32) content using a plurality of different download processes and saving (34) the downloaded content.

In many embodiments, these different download processes can be integrated with a download manager as plug-ins. Download managers that utilize plug-in download processes allow for a versatile design where any number of download processes can be utilized flexibly as a plug-in of a download manager rather than preloaded into a device or fixed in device firmware.

In a number of embodiments, plug-in download processes download content files to the local storage of a network connected device. Local storage can refer to storage in memory integrated as part of a network connected device's firmware or even in memory which can be disconnected from the network connected device, such as an external hard drive connected to a network connected device such as a network connected personal computer or a network drive.

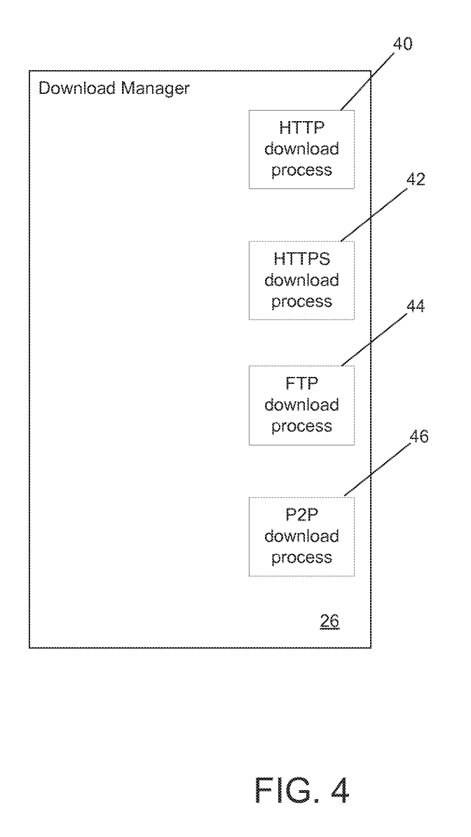

Various different plug-in download processes can be utilized as a plug-in for a download manger in accordance with embodiments of the invention. A download manager incorporating various plug-in download processes is accordance with an embodiment of the invention is illustrated in FIG. 4. The download manager 26 includes a plurality of plug-in download processes that the download manager can utilize to simultaneously download different portions of content. In the illustrated embodiment, the different download processes include an HTTP download process 40, an HTTPS download process 42, an FTP download process 44 and a P2P download process 46. In operation, these download processes can download a single file over a network from different sources using HTTP, HTTPS, FTP and P2P. In other embodiments, these download processes may download a single file from different sources using P2P and HTTP, HTTPS or FTP. In a multitude of embodiments, these download processes may download a single file from a single or multiple different sources using any type of download process, including but not limited to HTTP, HTTPS, FTP and P2P processes. In many embodiments, downloading content by different processes includes separating a file of content into chunks or byte ranges and downloading the chunks using different download processes.

Download mangers in accordance with many different embodiments of the invention can be implemented as a background process. A background process describes a process that runs independent of user intervention, as opposed to a process such as word processing that requires active user intervention to be useful. Allowing download managers to run as background processes further enhances the ease at which a user can utilize the download manager as the user need not actively intervene to instruct the download manager on how to operate.

### Allocating Portions of Content to Different Download Processes

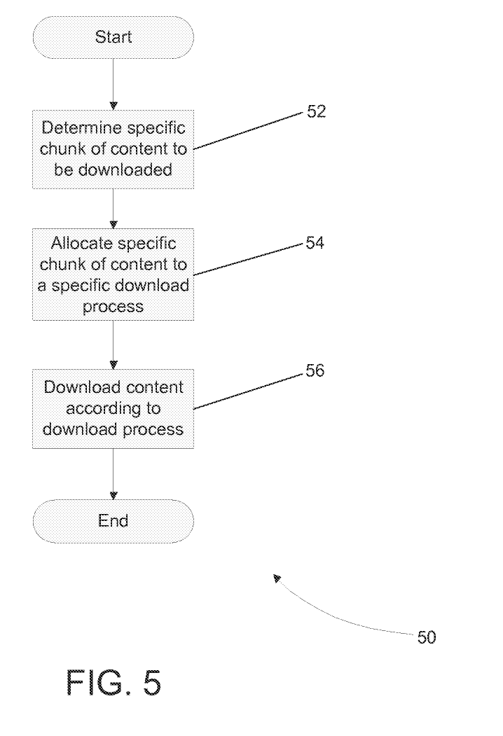

A process for downloading content by allocating each chunk or portion of content to be downloaded using a different process in accordance with an embodiment of the invention is illustrated in FIG. 5. The process 50 includes determining (52) the specific chunk of content to be downloaded, allocating (54) the specific chunk to a specific download process and downloading (56) the chunk according to the allocated download process. In many instances, chunks of content that are required within a short time deadline are downloaded using processes that are likely to guarantee low latency delivery of the chunk can be directly requested from a content server (e.g. using HTTPS). Chunks of content that will not be played back beyond a threshold amount of time can be downloaded using processes that do not burden the content server (e.g. using P2P download processes). As content is played back, the majority of the burden for providing content to the network connected device will shift from the content server to other devices (e.g. peer network connected devices). In several embodiments, the content is stored within a single container file and the download processes verify that the same file is being accessed by each of the download processes before commencing the downloading of portions or chunks of the file. In a number of embodiments, a modified P2P process is utilized in which the portions of the file that are requested are not randomly determined by the download manager. In several embodiments, the P2P process randomly determines the portion of the file to download from amongst a subset of portions of the file.

Although specific download processes are discussed above, many different criteria can be utilized to determine the processes to utilize to download content using different download processes in accordance with embodiments of the invention. Accordingly, download managers and download processes can be implemented in any of a variety of configurations in accordance with embodiments of the invention.

Although the present invention has been described in certain specific embodiments, many additional modifications and variations would be apparent to those skilled in the art. It is therefore to be understood that the present invention may be practiced otherwise than specifically described, including various changes in the size, shape and materials, without departing from the scope and spirit of the present invention. Thus, embodiments of the present invention should be considered in all respects as illustrative and not restrictive.

What is claimed is:

1. A network connected device, comprising:
a processor;
memory containing a download manager application;
wherein the download manager application configures the processor to utilize a plurality of different download processes to download portions of the same piece of content from at least one download source.

2. The network connected device of claim 1, wherein the plurality of different download processes are plug-ins to the download manager application.

3. The network connected device of claim 1, wherein the plurality of different download processes comprise a HTTP download process and a P2P download process.

4. The network connected device of claim 1, wherein at least one of the plurality of different download processes are selected from the group consisting of HTTP, HTTPS, FTP and P2P download processes.

5. The network connected device of claim 1, wherein the download manager application includes a player configured to playback partially downloaded content.

6. The network connected device of claim 1, wherein the download manager application is configured to download content from a single download source.

7. The network connected device of claim 1, wherein the download manager application is configured to download content from a plurality of download sources.

8. The network connected device of claim 1, wherein the download manager application is configured to operate as a background process.

9. A method of downloading a piece of content using a network connected device, the method comprising:
downloading portions of a piece of content from at least one download source utilizing a plurality of different download processes using a network connected device; and
storing the portions of downloaded content on the network connected device.

10. The method of claim 9, wherein downloading portions of a piece of content from at least one download source utilizing a plurality of different download processes comprises:
determining a portion of content to be downloaded;
allocating the portion of content to one of the plurality of download process; and
downloading the portion of content according to the download process.

11. The method of claim 9, wherein the plurality of different download processes are plug-ins to a download manager application that configures the network connected device to download portions of a piece of content from at least one download source using the plurality of different download processes.

12. The method of claim 9, wherein the plurality of different download processes comprise a HTTP download process and a P2P download process.

13. The method of claim 9, wherein at least one of the plurality of different download processes is selected from the group consisting of HTTP, HTTPS, FTP and P2P download processes.

14. The method of claim 9, further comprising playing back the partially downloaded piece of content during the downloading of the piece of content using the network connected device.

15. The method of claim 9, wherein portions of the piece of content are downloaded from a single download source.

16. The method of claim 9, wherein portions of the piece of content are downloaded from a plurality of download sources.

17. A machine readable medium containing processor instructions, where execution of the instructions by a processor causes the processor to perform a process comprising:
downloading portions of a piece of content from at least one download source utilizing a plurality of different download processes using a network connected device; and
storing the portions of downloaded content on the network connected device.

18. The machine readable medium of claim 17, where the process of downloading portions of a piece of content from at least one download source utilizing a plurality of different download processes further comprises:
determining a portion of content to be downloaded;
allocating the portion of content to one of the plurality of download process; and
downloading the portion of content according to the download process.

19. The machine readable medium of claim 18, wherein the machine readable medium is non-volatile memory.
